(19) United States
(12) Patent Application Publication
(10) Pub. No.: US 2026/0341549 A1
(43) Pub. Date: Oct. 29, 2026

(54) Waste Vitrification System

(71) Applicant: Radom Corporation, West Allis, WI (US)

(72) Inventors: Kenshin Ushiroda, Greendale, WI (US); lan McKinney, Mequon, WI (US); Elizaveta Grushnikova, Milwaukee, WI (US); Qi Rao, Sussex, WI (US); Velibor Pikelja, Milwaukee, WI (US); Jovan Jevtic, West Allis, WI (US)

(21) Appl. No.: 19/656,328

(22) Filed: Apr. 23, 2026

Related U.S. Application Data
(60) Provisional application No. 63/793,121, filed on Apr. 23, 2025.

(51) Int. Cl. G21F 9/30; C03B 5/00; C03B 5/02

(52) U.S. Cl. CPC G21F 9/305; C03B 5/005; C03B 5/023

(57) ABSTRACT

A vitrification system includes heater stocks that can extend upward through melt contained in a crucible to a position adjacent to the freshly introduced material for vitrification, reducing the heat isolating effects of an upper calcine layer.

### STATEMENT REGARDING FEDERALLY SPONSORED RESEARCH OR DEVELOPMENT

### Cross Reference to Related Application

This application claims the benefit of U.S. provisional application 63/793,121 filed Apr. 23, 2025, and hereby incorporated by reference.

### Background of the Invention

The present invention relates to systems for waste vitrification, for example, for use with radioactive waste, and in particular to a vitrification system that provides higher throughput with reduced offsetting emission of radioactive gas.

Vitrification is a process where radioactive materials are mixed with glass-forming chemicals and solidified into a glassy material allowing safer handling and disposal. In such systems, the waste and glass-forming chemicals may be mixed with water to form a slurry that is introduced into an enclosed crucible. In the crucible, the materials are heated to a high temperature (approximately 1150 °C) to produce a melt that may be withdrawn and cooled to form glass locking in place the radioactive components.

During this process, distinct layers of material are formed in the crucible including a lowermost layer of the melt, a calcine layer above the melt where calcining and other reactions take place, and a cold cap positioned above the calcine layer including the recently introduced slurry of radioactive material and glass-forming chemicals.

The process of vitrification is limited by the rate of heat transfer from the molten melt into the calcine layer and is limited by the inherent thermal resistance of the materials and in some cases a bubble layer forming between the melt and the calcine layer. The temperature of the melt can be increased, typically using electrodes passing current through the melt; however, such excess melt temperatures can increase the volatilization and emission of radioactive gases.

One approach to introducing additional heat into the calcine layer, without unduly promoting volatilization, is to direct a beam of microwaves downwardly through the cold cap into the calcine layer to heat the calcine layer by microwave energy absorption. A system using this approach is described in US patent publication 2022/013056, hereby incorporated by reference. This approach requires careful control of the microwaves to prevent volatilization of the material of the cold cap and a method of steering the microwaves over different regions of the crucible.

### SUMMARY OF THE INVENTION

The present invention employs heater stalks that may pass upward through the melt to locally apply heat proximate to the calcine layer from beneath the calcine layer. In this way increased volatilization of the cold cap and excess temperatures of the melt are avoided. Generally, the stalks may provide for microwave or resistance heating. A circulation of the melt and calcine layer among the stalks can be provided by an arrangement of electrical current flow from the immersed electrode heaters and an applied magnetic field producing an effective homopolar motor circulating the conductive melt within the crucible.

These particular objects and advantages may apply to only some embodiments falling within the claims and thus do not define the scope of the invention.

### BRIEF DESCRIPTION OF THE DRAWINGS

FIG. 1 is an elevational cross-section of a simplified vitrification system providing a crucible with through-melt, heater stalks to conduct heat proximate to the calcine layer;

FIG. 2 is a fragmentary detail cross-section of a microwave heater stalk;

FIG. 3 is a figure similar to FIG. 2 showing an electrical resistance heater stalk; and

FIGS. 4a-4c are top, side elevational and top views, respectively, of the crucible of FIG. 1 showing an interaction of electrical current flow and magnetic fields to produce a circulation of material around the heater stalks.

### DETAILED DESCRIPTION OF THE PREFERRED EMBODIMENT

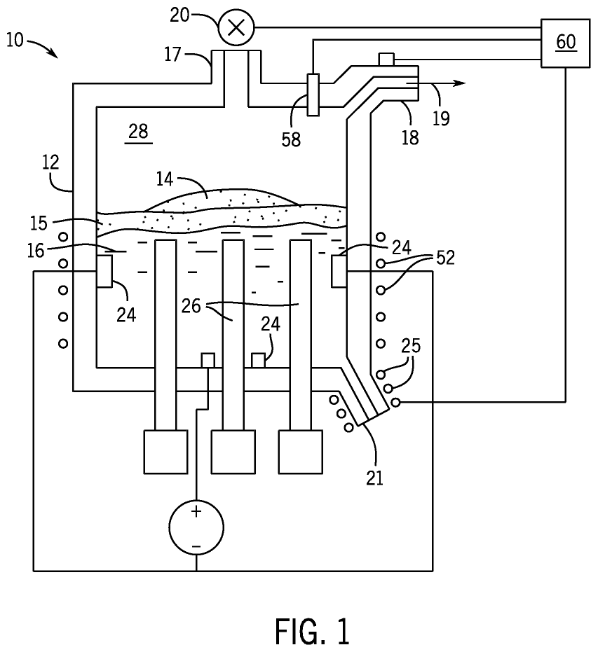

Referring now to FIG. 1, a vitrification system 10 may provide for a refractory lined crucible 12 defining an enclosed volume in which a vitrification of waste will be performed. During this vitrification process, introduced radioactive waste and glass-forming chemicals pass through stages of an upper cold cap layer 14, a calcine layer 15 positioned below the upper cold cap layer 14, and finally a melt 16 of molten vitreous material positioned beneath the calcine layer 15. The cold cap layer 14 generally provides a water-based slurry of radioactive material and glass-forming chemicals such as silica. The calcine layer 15 is comprised of the glass-forming chemicals and radioactive material after the water has evaporated during reaction to produce glass, and the melt 16 is a completed vitreous material in molten form.

A waste receipt channel 17 communicates with the enclosed volume of the crucible 12 above the cold cap layer 14 and allows for the introduction of slurry of the cold cap layer 14. The waste receipt channel 17 may include a flow control valve 20 to control the feed rate of slurry while minimizing the introduction or escape of gas and heat. An exit channel 18, also communicating with the enclosed volume of the crucible above the cold cap layer 14 provides for the release of volatilized gases 19. These gases 19 may include radioactive components and will be subject to further treatment and, for this reason, are desirably minimized.

The crucible 12 may further include an outlet port 21 positioned near the bottom of the crucible beneath the melt 16 allowing the melt 16 to be removed from the crucible 12 for solidification into glass. Control of the outlet port 21 may be managed through the use of inductive heating coils 25 that melt or allow the solidification of a plug of material within the channel of the port 21.

The crucible 12 may be constructed of any suitable material capable of handling temperatures in excess of melt temperatures of approximately 1150 °C including, for example, of refractory ceramic. An outer shell, for example, of stainless steel may provide additional structural support. Desirably the walls of the crucible 12 are magnetically permeable as will be discussed below.

A lower inner portion of the crucible 12 may support electrodes 24, for example, formed of graphite and placed in contact with the melt 16 beneath the surface of the melt 16. Electrical current flowing through the electrodes 24 may provide resistive heating of the melt 16 to maintain the melt 16 in molten form and to introduce heat that will assist reacting and melting the material of the calcine layer 15. The electrodes 24, if constructed of graphite, are preferably coated with zirconia, silicon carbide, boron nitride, or another protective coating to minimize graphite consumption and prolong useful life.

Referring still the FIG. 1, a set of heater stalks 26 may be positioned to extend upwardly through a bottom of the crucible 12 to a height terminating near a lower surface of the calcine layer 15, for example, within 3 cm and preferably within 1 cm. The distal upper ends of the heater stalks 26 are positioned to provide heat directly to the calcine layer 15 without the need to elevate the temperature of other portions of the melt 16. Typically the distal upper ends of the heater stalks 26 will be within 1 foot or within 6 inches of the calcine layer 15, or within 3 inches or less than 1 inch. As will be explained in greater detail below, the heater stalks 26 may be placed at different distances from a center of the crucible 12 to promote the dispersion of heat to various portions of the calcine layer 15 with circulation of the melt 16 about a vertical central axis 28.

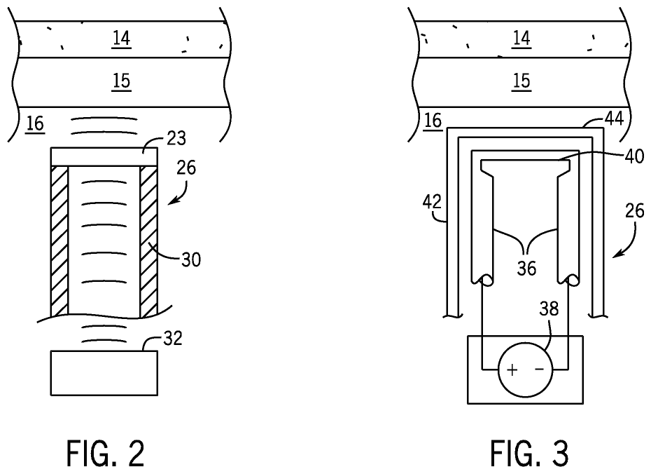

Referring generally to FIG. 2, in a first embodiment, each heater stalk 26 may comprise a vertically extending electrically conductive tube 30 providing a microwave waveguide. For this purpose, the conductive tube 30 is desirably constructed of a chemically resistant and heat resistant material that is either fully electrically conductive, such as a doped silicon carbide, or provides an electrically conductive coating on a chemically resistant material such as alumina. The conductive tubes 30 communicate at their lower proximal ends with corresponding microwave generators 32, for example, klystrons, providing a power output in excess of 1 kW, and, for example, from 50 kW to 600 kW or more to provide substantial heating energy.

An upper distal end of the conductive tubes 30 is enclosed by a nonconductive cap 23, for example, alumina, allowing the emission of microwave electromagnetic radiation upwardly from the distal end of the conductive tubing 30, for absorption into the calcine layer 15 with little or no direct heating of the cold cap 14.

Referring to FIG. 3, in an alternative embodiment, electrical resistance heating may be provided, for example, by high-temperature electrical conductors 36 extending upward from a power supply 38 positioned outside of the crucible 12. The electrical conductors 36 provide current through a heating element 40 adjacent to the distal end of the heater stalk 26 heating the calcine layer 15 by thermal conductivity. In one embodiment, the high temperature electrical conductors 36 may be silicon carbide, optionally doped for increased conductivity, and having a proportionally larger cross-section for low resistance. The distal ends of the electrical conductors 36 connect to a narrower filament of higher resistance silicon carbide (through lack of doping and/or cross-sectional area reduction) forming a resistive heating element 40. The heating element 40 and the electrical conductors 36 may be enclosed in a protective tube 42 and end cap 44 covering the distal end of the tube 42, both constructed of a high-temperature refractory material such as alumina or silicon carbide. This enclosure prevents material of the melt 16 from flowing into the tube 42 and into contact with the electrical conductors 36 or resistive heating element 40.

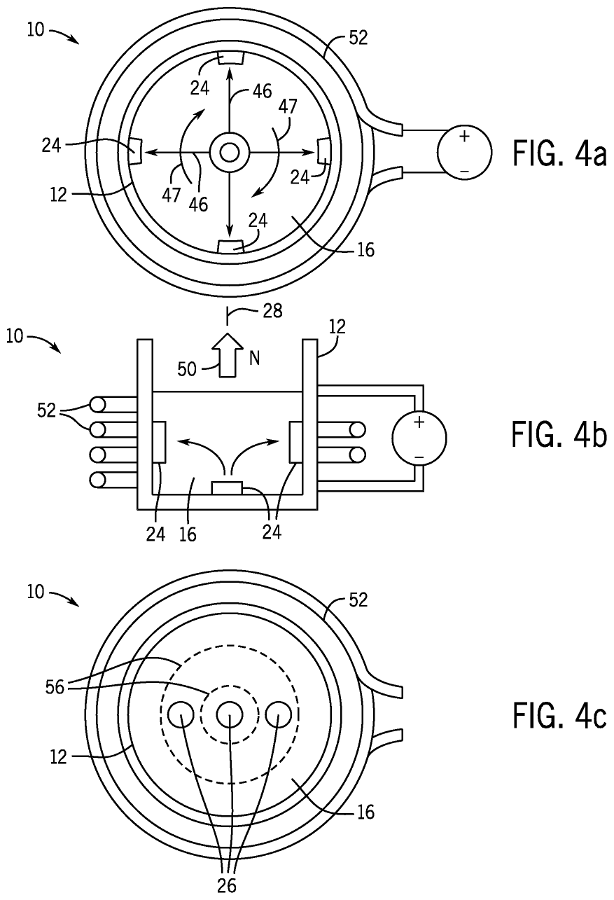

Referring now to FIGS. 4a-4c, the electrodes 24 within the cavity 12 providing a heating current through the melt 16 may be arranged so as to provide an outwardly radially directed electrical current 46 from a centermost electrode 24 positioned near the bottom of the crucible 12 to radially outwardly displaced electrodes 24 placed on the inner vertical walls of the crucible 12. A vertically oriented magnetic field 50 may be generated, for example, by a solenoid coil 52 wrapped around the crucible 12 to provide a looping current flow around the vertical axis 22. Current flow through the melt 16 in the horizontal direction enforced by the electrodes 24 is perpendicular to the magnetic field causing a rotational force 47 on the conductive melt 16 circulating the melt 16 about the central axis. With this circulation, the distal heating portions of the heater stalks 26 sweep circular paths 56 through the melt 16 to provide more uniform heating of the overlying calcine layer 15.

Referring again to FIG. 1, a correct positioning of the top of the heater stalks 26 with respect to the bottom of the calcine layer 15 is ensured by a feedback control using a height sensor 58, for example, an ultrasound, laser, or radar rangefinder, determining the height of the calcine layer 15 and providing a signal to a controller 60 which can control the valve 20 and the heating coils 25 to maintain the level of the calcine layer 15 at a constant position. The controller 60 may also received a signal from a radiation monitor 61 to control the temperature of the heater stalks 26 to minimize radioactive outgassing. It will be appreciated that other height sensing mechanisms may be used including, for example, multiple thermal sensors positioned along a wall of the crucible 12 to monitor a temperature profile and temperature discontinuities.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” can be understood to include one or more processors that can communicate in a stand-alone and/or a distributed environment(s), and can thus be configured to communicate via wired or wireless communications with other processors, where such one or more processor can be configured to operate on one or more processor-controlled devices that can be similar or different devices.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A vitrification system comprising:
a crucible providing a volume adapted to hold a melt at temperatures in excess of 1000 °C, the melt presenting an upper surface having an overlying calcine layer; and
a set of heater stalks extending within the crucible upwardly through the melt to position distal ends of the heater stalks adjacent to the calcine layer to provide heat from the distal ends of the heater stalks to the calcine layer.

2. The vitrification system of claim 1 wherein the heater stalks are tubes having a conductive inner surface providing a microwave waveguide; and
further including at one least microwave generator communicating with proximal ends of the heater stalks to transmit microwave energy along the tubes to the distal ends of the heater stalks.

3. The vitrification system of claim 2 wherein the at least one microwave generator provides a power output in excess of 50 kW.

4. The vitrification system of claim 2 wherein the distal ends of the heater stalks are closed by an electrically nonconductive cap.

5. The vitrification system of claim 1 wherein the heater stalks are tubes closed at the distal ends and holding an electrical resistance heater adjacent to the distal ends; and
further including a source of electrical power communicating through conductive leads with the electrical resistance heater to transmit heat energy from the distal ends of the heater stalks.

6. The vitrification system of claim 1 wherein the heater stalks are constructed of a refractory material.

7. The vitrification system of claim 1 wherein the crucible further includes separated electrodes for receiving electrical power to transmit current through the melt for heating of the melt.

8. The vitrification system of claim 7 further including a magnet positioned with respect to the current through the melt to promote circulation of the melt by Lorentz force to move the melt past the distal ends of the heater stalks.

9. The vitrification system of claim 1 further including a height sensor determining a height of the melt within the crucible for controlling introduction of material into the crucible to maintain a predetermined distance between the calcine layer and distal ends of the heater stalks.

10. A method for vitrification of radioactive waste comprising:
(a) introducing the waste into a crucible providing a volume adapted to hold molten waste as a melt at temperatures in excess of 1000 °C, the melt presenting an upper surface having an overlying calcine layer; and
(b) heating the calcine layer with a set of heater stalks extending within the crucible upwardly through the melt to position distal ends of the heater stalks adjacent to the calcine layer providing heat from the distal ends of the heater stalks to the calcine layer.

11. The method of claim 10 wherein the heater stalks are tubes having a conductive inner surface providing a microwave waveguide and further including at least one microwave generator communicating with proximal ends of the heater stalks to transmit microwave energy along the tubes to the distal ends of the heater stalks.

12. The method of claim 11 wherein the at least one microwave generator provides a power output in excess of 50 kW.

13. The method of claim 11 wherein the distal ends of the heater stalks are closed by an electrically nonconductive cap.

14. The method of claim 10 wherein the heater stalks are tubes closed at the distal end and holding an electrical resistance heater adjacent to the distal ends; and
further including a source of electrical power communicating through conductive leads with the electrical resistance heater to transmit heat energy from the distal ends of the heater stalks.

15. The method of claim 10 wherein the heater stalks are constructed of a refractory material.

16. The method of claim 10 wherein the crucible further includes separated electrodes for receiving electrical power to transmit current through the melt for heating of the melt.

17. The method of claim 16 further including a magnet positioned with respect to the current through the melt to promote circulation of the melt by Lorentz force to move the melt past the distal ends of the heater stalks.

18. The method of claim 10 further including monitoring a height of the melt within the crucible and controlling introduction of material into the crucible to maintain a predetermined distance between the overlying calcium layer and distal ends of the heater stalks.
